(19) United States
(12) Patent Application Publication
(10) Pub. No.: US 2003/0033325 A1
(43) Pub. Date: Feb. 13, 2003

(54) Method and system for providing audio and/or video tracks

(76) Inventor: Richard Hendricus Johannes van den Boogaard, Castricum (NL)

Correspondence Address: BLANK ROME COMISKY & MCCAULEY, LLP, 900 17TH STREET, N.W., SUITE 1000, WASHINGTON, DC, 20006, US

(21) Appl. No.: 10/229,395

(22) Filed: Aug. 28, 2002

Related U.S. Application Data
(63) Continuation of application No. PCT/NL01/00168, filed on Feb. 28, 2001.

(30) Foreign Application Priority Data
Feb. 29, 2000 (NL) 1014520
May 31, 2000 (NL) 1015363

(51) Int. Cl. G06F 17/30

(52) U.S. Cl. 707/200

(57) ABSTRACT

In a method and system a number of digital audio and/or video files is made available by a first party to a second party. The files comprise at least a first file and a second file following the first file. An intermediate segue file with a mix of an end segment and a start segment of the second file is created. Also, a first shortened file with the first file without the end segment thereof is created. Further, a second shortened file with the second file without the start segment thereof is created. The first shortened file, the intermediate segue file and the second shortened file are transferred to the second party. The first file and the second file may originate from different sources. In making available a first digital audio and/or video file by a first party to a second party, further an end segue file with a mix of an end segment of the first file and another file, and a shortened file with the first file without the end segment thereof may be created, after which the shortened file and the end segue file are transferred to the second party. Also a start segue file with a mix of a start segment of the first file and another file, and a shortened file with the first file without the start segment thereof may be created, after which the shortened file and the start segue file are transferred to the second party.

### CROSS-REFERENCE TO RELATED APPLICATION

This is a continuation application of PCT/NL01/00168 filed Feb. 28, 2001, which PCT application claims priority of Dutch patent application number 1014520 filed Feb. 29, 2000 and 1015363 filed May 31, 2000, all herein incorporated by reference.

### FIELD OF THE INVENTION

This invention relates to making available audio and/or video files.

### BACKGROUND OF THE INVENTION

Thanks to the arrival of digital audio technology, the music industry has been able to sell more copies than ever: shortly after the introduction of the compact disc in the eighties, the superior sound quality compared to analogue predecessors such as vinyl and audio cassette induced consumers to replace their entire collections and to buy new music on the same platform. This generated an enormous replacement demand and thus substantial profits for the music industry. Up to now, the movie industry did not enjoy such a digital replacement demand, although the digital versatile disc (DVD) is coming on. Also, a large market seems to exist for video on demand through cable, satellite or wireless networks.

As usage of digital technology has evolved, the audio-visual industry seems to have hailed in a Trojan horse. In essence digital technology means a one or a zero, sound or no sound, image or no image, without any lesser quality levels in between. In copying, no loss of quality occurs, regardless of whether it concerns the first or one-thousandth generation copy. As sound requires less data than images, copying of three minutes of film is more cumbersome than copying three minutes of music.

The compression technology MPEG-1 Layer III (MP3, in short) has become a major threat to the music industry, as it takes away

the basis for revenue generation. This basis traditionally is the management of the copy (the compact disc), rather than management of the original (the artist). By now, MP3 is a fact, and defensive actions such as the Secure Digital Music Initiative (SDMI) have not been able to curb or prevent the popularity of the file format.

An audience that has already embraced MP3 as the de facto standard will never accept “SDMI compliant” standards. This is the most important lesson learned from a comparable battle between video standards Betamax (Sony), V2000 (Philips) and VHS (Matsushita) in the early eighties. Although the quality of the first two was superior to the latter (compare the arguments of better compression by which at the moment certain SDMI compliant standards are recommended), VHS opened her format for all kinds of content, including the much-wanted porno and, as a result, prevailed. Betamax and V2000 realized the importance of content too late. The analogy to MP3 is that the format has already passed the content test, although the majority concerns the distribution illegal copies, without consent of the copyright owners.

The money spent on development of alternative “SDMI compliant” formats, such as Liquid Audio, Sony's Open MG's Atrac3, AT&T's a2b, Lucent's PAC, VQF and others, is most likely wasted. These alternatives will never evolve to a formal standard, unless the music industry forces its acceptance by taking away the source for creation of MP3 files, being the digital music itself (as available on compact disc) and starts offering music exclusively through one of these “safe” file formats. Such a strategy is highly unlikely.

Recording devices and/or software such as available from Voquette.com and super video recorders such as TiVo and ReplayTV show the inherent weakness of encryption systems. Although the file indeed is safe while in transit, a new digital unprotected copy may always be created during or after the decoding process from the analogue and/or digital audio and/or video signal.

Being the current de facto standard, MP3 changes the way music is disseminated through culture. MP3 therefore is more than a standard; it also represents a cultural movement. Without the explosive growth of the Internet MP3 would have been only a clever compression algorithm. Creation of MP3 files at home from one's own compact disc is (currently) not considered to be illegal. However, sharing these files with others through CD-recordables or via the Internet, possibly with the help of applications such as Napster or MP3.com's Listening Service and Beam-IT software—without consent of the copyright holders—indeed is illegal.

Copying of information in a world of digital networks does no right to the creators of specific forms of information, such as music or motion picture. Artists deserve to be paid for their creative efforts. However, the basis on which they are paid is likely to change, as the traditional value chain collapses and is replaced by a reality of networked audio and video. As the price of the copy approaches zero, the loss of intermediaries that add costs, but no value in the value chain will slowly but surely become a reality.

Anyone who listens to music or watches video in fact is creating a (temporary) copy. As a consequence, listening/viewing is copying. However, there is a crucial difference between the creation of a copy with the aim of keeping it, and the creation of a copy which aims to satisfy a (temporary) listening and/or viewing experience. The latter is also referred to as an ephemeral copy.

At the moment, the technology behind file-swapping programs for audio such as Napster and Gnutella mainly focuses on the possibility of creating of an (illegal) permanent copy. The music industry has every right to act against it. The more fundamental change behind applications such as Napster is that it changes (part of) the function of the server as supplier of content to clients in the network. With Napster, users do not download from a central server, but directly from each others machines. In this process, the Napster server only has a coordinating role. Applications that followed the development of Napster, such as Gnutella, do not even use a centralized server any more.

Because less data traffic is required between a single server and many clients (clients exchange files or parts of files with each other), it becomes possible to increase the number of individual streams, which moreover, in contrast to broadcast transmissions, can function independently from time as a factor. This “client as server” technology exists today and may or may not be patented.

Data traffic between clients without a required, centralised intervention of a server is commonly known as “peer-to-peer” relations. Passing files from one client to another is also used in “multicasting” or “chaining” technologies: however, in such cases it concerns an identical signal which is passed on real-time, not a unique signal requested by an individual user and consequently functioning independently from time. Time independence as a factor is only possible in multicasting if buffering in the network takes place (also referred to as “caching”).

So far the music industry has been unable to curb MP3. Recent developments even seem to embrace the format. An interesting question therefore becomes how the industry can try to make best use of the format instead of trying to fight it. Remarkably, TV-broadcasters and advertisers do not seem to be worried about the arrival of new supervideorecorders such as TiVo and ReplayTV which may be a similar threat with their recording capacity of about 30 hours and possibility to skip commercials. Undoubtedly, this will have something to do with the ephemeral nature of television as a medium and the time available in a human being's life to view everything which is broadcast. As a result, some experts acclaim to the notion that the motive for the creation of a permanent copy is taken away as soon as consumers are reassured that content can be consumed on demand. However, creating copies serves another, possibly more important, goal: by placing content at the end user an important hurdle in distribution is taken away. When everyone would request a different movie at the same time, a network such as the Internet is not capable to deliver this content in real-time.

There are also opportunities for the hardware industry to use MP3 by manufacturing MP3 players. Nevertheless, this industry strongly needs legal audio, which is currently not offered by the traditional music industry, especially not in the unprotected MP3 format. Access to legal audio is crucial to be able to supply added value for their digital audio equipment.

Although current discussions focus on illegal distribution of audio files in MP3 format, the same problem seems imminent to video or moving pictures. The invention therefore relates to both audio and video.

### SUMMARY OF THE INVENTION

An object of the invention is to offer the entertainment industry (music and motion picture industry) and distribution industry (cable, telecom, and TV and/or radio stations) an alternative technology which does not focus on protection by creation of an alternative file format, using a combination of serial copy management systems (scms), encryption or watermarking technologies.

Another object of the invention is to use any standard file format, more specifically the “open” MP3 format for audio (=MPEG-1 layer III) and MPEG for video.

Also an object of the invention is to use existing techniques as used in traditional broadcast radio and translate and broaden them to a digital reality, which satisfies both the needs of the entertainment industry (delivering audio and/or video in a form which cannot be copied) and the wishes of the consumer (access to legal audio and/or video, possibility to create a personal playlist at least partially by oneself, and the possibility to skip audio and/or video).

Yet another object of the invention is to satisfy the needs of the distribution industry to control the sequence of individual playlists, in order to accomodate programming of commercials etc.

Another object of the invention is to make copying unattractive rather than impossible for consumers, or at least difficult (for hackers).

Yet another object of the invention is to provide the hardware industry with a technology that allows access against a compensation to legal audio and video as a result of assent from the entertainment and distribution industry with the technology. This adds value to their digital devices.

An object of the invention also is to enable internet radio stations and Internet TV stations to offer audio and/or video which can be (partially) customised by the end user and listened to or viewed via networks such as cable, satellite, DAB, DVB, GPRS or UMTS, downloaded to digital audio and/or video devices, such as MP3 players and third generation mobile phones, Internet set-top boxes for TVs and supervideorecorders, or recorded on recordable and rewritable digital carriers such as CD, CD-R, CD-RW, DVD, DVD-R, DVD-RW, optical discs, RAM memory chips and comparable data carriers.

Another object of the invention is to enable the music industry to produce audio and/or video which makes it impossible for individual users to copy a track in full, while not diminishing the pleasure of listening to or viewing complete tracks, although mixed with other tracks.

A further object of the invention is to offer new audio and/or video based on individual or shared profiles of end users and offer these end users an opportunity to rate the audio and/or video, and/or to buy the audio and/or video on a compact disc, digital versatile disc (DVD) (or a direct download) from an online e-commerce website. Buying profiles enables retailers (and/or the companies) to operate purposeful to target groups or individuals.

Yet another object of the invention is to provide consumers access to all sorts of audio and/or video, instead of to a selection which is limited to one specific content provider, a specific musical genre (Top40, alternative, jazz etc.) or movie genre, which gives the consumer the opportunity to influence a playlist directly or indirectly, while the consumer can also be kept up-to-date on new releases of music or movies.

Yet another object of the invention is to enable a more efficient distribution of unique audio and/or video files by combining the invention with the “client as server” principle, which uses (partial) recording of audio and/or video at the side of the individual user, while maintaining a method of control of the server.

Also an object of the invention is to combine distribution technologies with each other, such as DAB/DVB with Internet or DAB/DVB with GPRS/UMTS.

The above and other object are achieved through the features according to the annexed claims.

Central thought to the invention is the notion that nobody is interested in keeping copies of audio and/or video tracks which are levelled out to a certain audio and/or video level, and mixed with other audio and/or video tracks, jingles, comments from DJs or commercials. The possibility that users want to create a permanent copy of such tracks is as slim as the number of people making recordings from traditional broadcast radio and/or television.

### BRIEF DESCRIPTION OF THE DRAWINGS

FIG. 1 is a schematic representation of server-side creation of audio and/or video segments and segues and client-side playback of a playlist tracks A, B, C.

FIG. 2 is a schematic representation of server-side creation of audio and/or video segments and segues and client-side playback of a playlist track C, info tracks D & E and track F.

FIG. 3 is a schematic representation of the creation of separate audio tracks which are combined with a unique SID coding.

FIG. 4 is a schematic representation of the creation of a mixed segue, consisting of a combination of two separate audio tracks and which merges assigned unique SID codes to a new SID code in the encoder.

FIG. 5 is a schematic representation of the bitstream organisation in an MPEG-1 layer III file according to source ISO11172-3, FIG. 3-A.7.1.

FIG. 6 is a schematic representation of the bitstream organisation in an MPEG-1 layer III file with an audio peak in “main info 3” and minimal data demand for “main info 2” according to source ISO11172-3, FIG. 3-A.7.2.

FIG. 7 is a schematic representation of an edit function in MPEG-1 layer III files.

FIG. 8 is a schematic representation of the use of the skip function in the SID protocol.

FIG. 9 is a schematic representation of the use of a skip function at the side of a client, where a user skips forward from audio and/or video track A to B, or skips backward from audio and/or video track B to A.

FIG. 10 is a schematic representation of the use of a skip function at the side of a client, where a user skips forward from audio and/or video track A to B.

FIG. 11 is a schematic representation of the use of a skip function at the side of a client, where a user skips backward from audio and/or video track B to A.

FIG. 12 is a schematic representation of a communication process between a client and a server.

FIG. 13 is a schematic representation of a communication process between, on the one hand, a client X and a server, and on the other hand, between the server and other clients, in particular client Y.

FIG. 14 is a schematic representation of a communication process between a client and a server, using a combination of a fixed network connection (e.g. Internet) and a broadcast (DAB/DVB) multiplex.

FIG. 15 is a schematic representation of a communication process between a client and a server, using a combination of a broadcast (DAB/DVB) multiplex and mobile networks.

FIG. 16 is a schematic representation of two applications of off-line use of the SID technology where the required tracks are recorded in fixed order in a memory or on a carrier.

FIG. 17 is a schematic representation of two applications of off-line use of the SID technologye where the required tracks for at random playback are recorded in a memory or on a carrier.

FIG. 18 is a schematic representation of a combination of the use of tracks recorded in a memory or on a carrier and complementary and other tracks on a server.

In the different figures the same reference symbols refer to the same components or components with a similar function.

Definitions of Used Terms

Client=apparatus receiving audio, video and/or info tracks from a server.

Client buffer=reserved permanent memory in a computer.

Distribution mechanism=fixed or mobile network connection, broadcast multiplex or recording in a memory or on a carrier.

End segue=combination (mix) of an end segment of a track with a jingle.

Jingle=any piece of audio or video, such as a person's voice, a commercial, an identificatin of a provider.

Mixing of audio=adding up two or more audio tracks, using techniques which replace one or more audio tracks gradually with one or more other audio tracks.

Mixing of video=adding up two or more video tracks, using techniques which replace one or more images gradually with one or more other images.

Online=connected with a fixed or mobile network.

Off-line=not connected to a fixed or mobile network, but using a memory or a recording instead.

Provider=party which makes available (distributes) audio and/or video tracks.

RAM=Random Access Memory, computer term for memory with an ephemeral character which can be reused.

Segue=combination (mix) of one or more tracks, with at least a part of two or more tracks being perceived during a certain period of time.

Server=apparatus which serves audio, video and/or info tracks to a client and records, and processes and records information from a client.

SID=segue identification.

Start segue=combination (mix) of a jingle and a start segment of a track.

Track=audio, video or information file.

Video track=the definition in this patent document includes vector-oriented moving images, such as flash movies as developed by Macromedia.

### DESCRIPTION OF PREFERRED EMBODIMENTS

The invention, herinafter also referred to as SID®, which is an acronym for Segue IDentification, offers a possibility for digital distribution of audio and/or video using specifically programmed computers via interactive networks such as, but not limited to, the Internet. Distribution of audio and/or video via mobile networks or in combination with broadcast networks is also possible. SID® is based on techniques already deployed in traditional radio, including levelling (equalization of sound levels), mixing and interrupting.

On traditional radio, music can rarely be listened to from beginning to end. Music is mixed and interrupted by DJ's, jingles and commercials. Music is also levelled out by a compressor, which prevents the listener from continuously having to turn up or down the volume of the radio. On television programmes are interrupted, but mixing or dissolve techniques are not used as frequently to take away an incentive for copying. Interruption by announcements and commercials apparently satisfies in the ‘broadcast’ era where different recipients receive an identical signal. The arrival of TV on demand and digital recording devices (TiVo and ReplayTV) which are sometimes equipped with a so-called “ad-skip” functionality (allowing users to skip forward 30 seconds in time in order to avoid commercials) may stimulate the use of mixes and dissolves of commercial messages in the future. The recording function of video recorders (even if they are digital) changes as real-time broadcasts are replaced by interactive, on the basis of individual demand or time-shifted individual actions from users.

The function of this digital video recorder, which in fact is nothing more than a large hard-disc with digital information, could in future evolve to a client in a network, like computers which at the moment are also connected on the Internet and mobile telephones in the mobile network. Apart from the traditional reception function of the client, this client could also send data, which is the function of a server in the network.

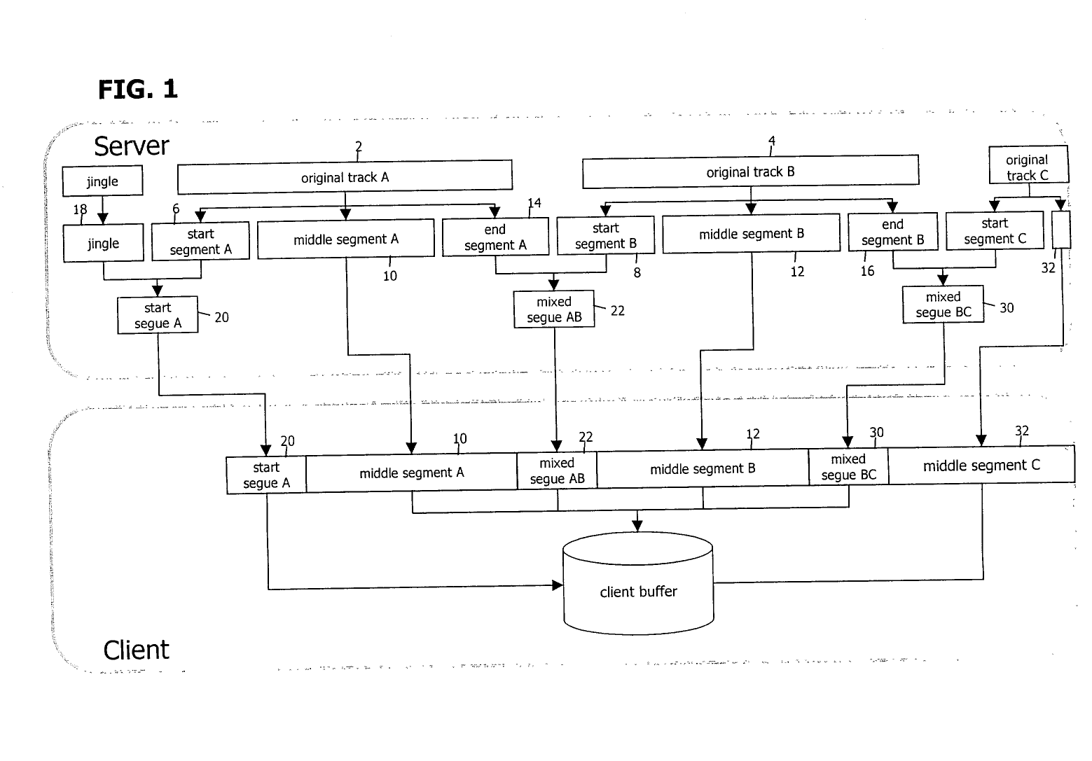

SID® translates these techniques to a new reality in which the network plays a prominent role. There are different implementations of the SID® technology. Essentially, SID® is a technology that allows the entertainment industry to “safely” distribute audio and/or video via interactive networks such as the Internet or mobile networks, possibly in combination with broadcast distribution technologies such as DAB and DVB. Each of these implementations will be discussed in the following paragraphs while referring to FIGS. 1-18.

SID® prevends users from obtaining complete tracks. When a server controls the original segments that together form a mix of tracks (segue), the server can determine where and when commercials and/or other interruptions are inserted. In the case of audio this will concern a segue between two sequential tracks, possibly interrupted by commercial messages. An implementation for video can break up a program in separate segments, analogue to time as a factor and/or arbitrarily on the basis of the program content (e.g. a “cliff hanger” in a TV program).

Basic Preferred Embodiment

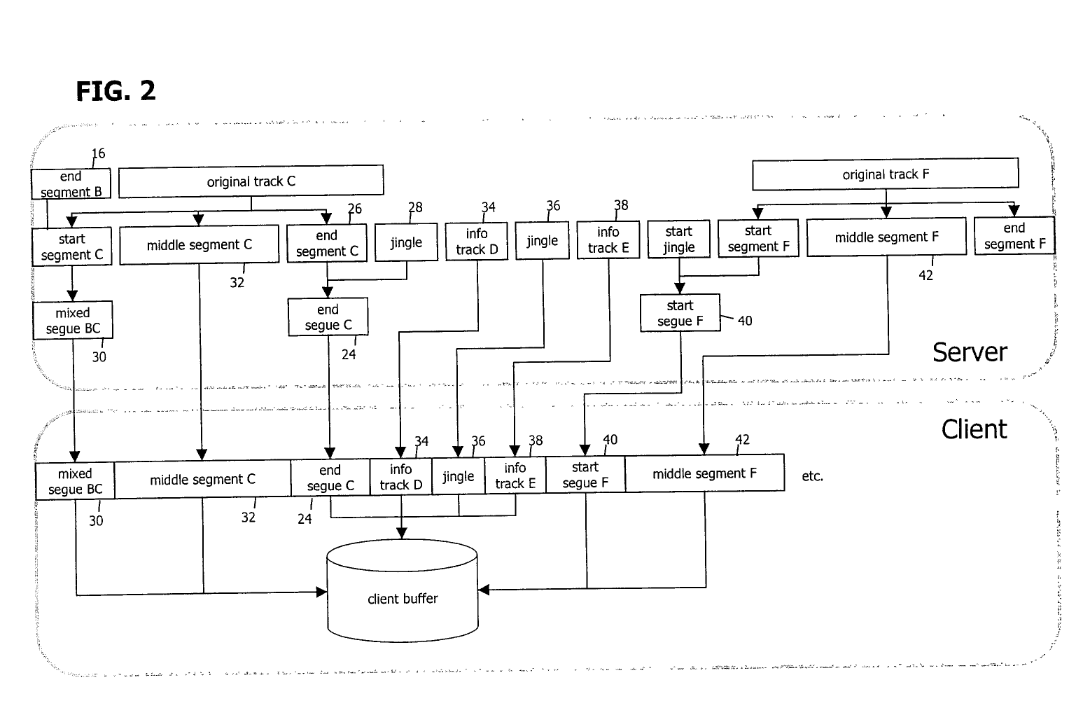

As FIGS. 1 and 2 demonstrate, the invention uses segues between two sequential music or picture files or other audio and/or video tracks, hereinafter referred to as tracks. At a server side, the original tracks can be processed with the aid of a computer program. In the preferred embodiment, the original tracks are segmented in three files. By way of example reference is made to “original track A” 2 and “original track B” 4, which are segmented in start segment A 6 and start segment B 8, middle segment A 10 and middle segment B 12 and end segment A 14 and end segment B 16 (FIG. 1). The start and end segments are mixed together, which creates new files, which are called segues. A segue is a term for combination or mix. By combining start segment A 6 with jingle 18 “start segue A” 20 is created, while a new file “mixed segue AB” 22 is created from a combination of the overlapping of end segment A 14 and start segment B 8 (FIG. 1). A different combination of files is the “end segue C” 24, as shown in FIG. 2, which is a combination of an end segment 26 of track C and a jingle 28. By the way, the start segues and end segues need not be mixed with a jingle. It is also possible to include an inaudible signal in the file, or to variably modulate the frequency levels. The object of these segues is to create a file from which the original parts of the constituting files cannot be obtained any more, in order to prevent subtraction. However, for simplicity and understanding, the figures refer to a mix with a jingle.

The similarity between the different forms of segue files is that during a certain period a combination of two or more files is perceptible. The middle segments, on the contrary, remain unchanged in principle. Mixing of middle segments with extra elements (such as jingles and voices) is not required for the protection offered by SID®, but is not excluded on the other hand. Breaking up the original file in more segments than the three mentioned above is a possibility, but does not add to an increased level of protection. In the discussion of this preferred embodiment a break-up of a track in three segments is assumed.

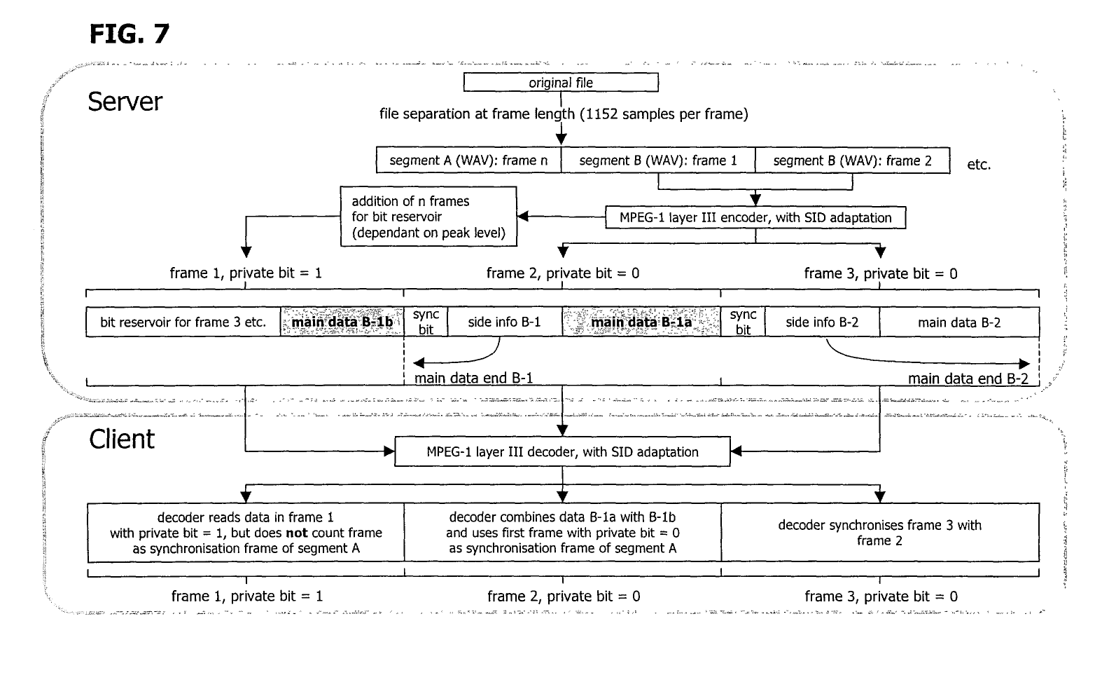

The mixed tracks (start segue, end segue and mixed segue) and non-mixed middle segments are created on the server-side and next transferred to a client or user as separate files via a distribution mechanism, and played back in chronological order, meaning start segue A 20, middle segment A 10, mixed segue AB 22, middle segment B 12. After this a mixed segue BC 30 may follow, which is a composite of overlapping areas of tracks B and C, followed by middle segment 32 of track C, etc. (FIG. 1). A middle segment may also be followed by an end segue (end segue C 24 in FIG. 2), followed by a possibly non-mixed info track D 34, jingle 36 and info track E 38 (FIG. 2). With the aid of an adapted version of the decoder (see “COMBINATIONS WITH NON-MIXED FILES (INFO TRACKS)” and FIG. 7) users play back the files, without having to realise that they listen to and/or watch five files for each two full tracks they hear and/or see. What they hear and/or see is a first track, where the beginning is mixed with a jingle, the segue from the first to the second track and the second track itself, which at the end again is mixed with a next track or jingle. To the user it is perceived as a fluent flow of at least two tracks. The different tracks, therefore, do not have to be represented visually as separate files.

The advantages of breaking up two subsequent files (‘tracks’) include:

Only with the aid of special editing software of with the help of an adapted version of the decoder users are capable of locally pasting together the original music in order to obtain a permanent, yet partially mixed, file;

The use of mixed segues prevents a user from ever obtaining the full original file (clean start segments and end segments are not available in an implementation of the invention, and cannot be derived from the mixed segue);

Sending files as separate packets via the Internet prevents data loss resulting from poor connections. This is particularly important for use of the technology when downloading music to an MP3-player or from video to a personal video player. Where existing transmission technologies such as packet switching focus on breaking up large files in many small packets and sending these separately in order to reassemble them to their original state on the receiver's side, SID® focuses on leaving the files as separate segments on the receiver's side. However, during playback these files as played continuously, without the receiver ever realising that a segue occurs from one file to another.

Breaking up of two original files and mixing them to a start segue, two middle segments, one mixed segue and an end segue offers an opportunity for exchange of these separate cut tracks between two clients, without requiring them to obtain all traffic from a central server. The server can suffice with the delivery of the mixed segue, creating more bandwidth to provide several clients with individual data. SID® technology therefore enables “mass individualisation”;

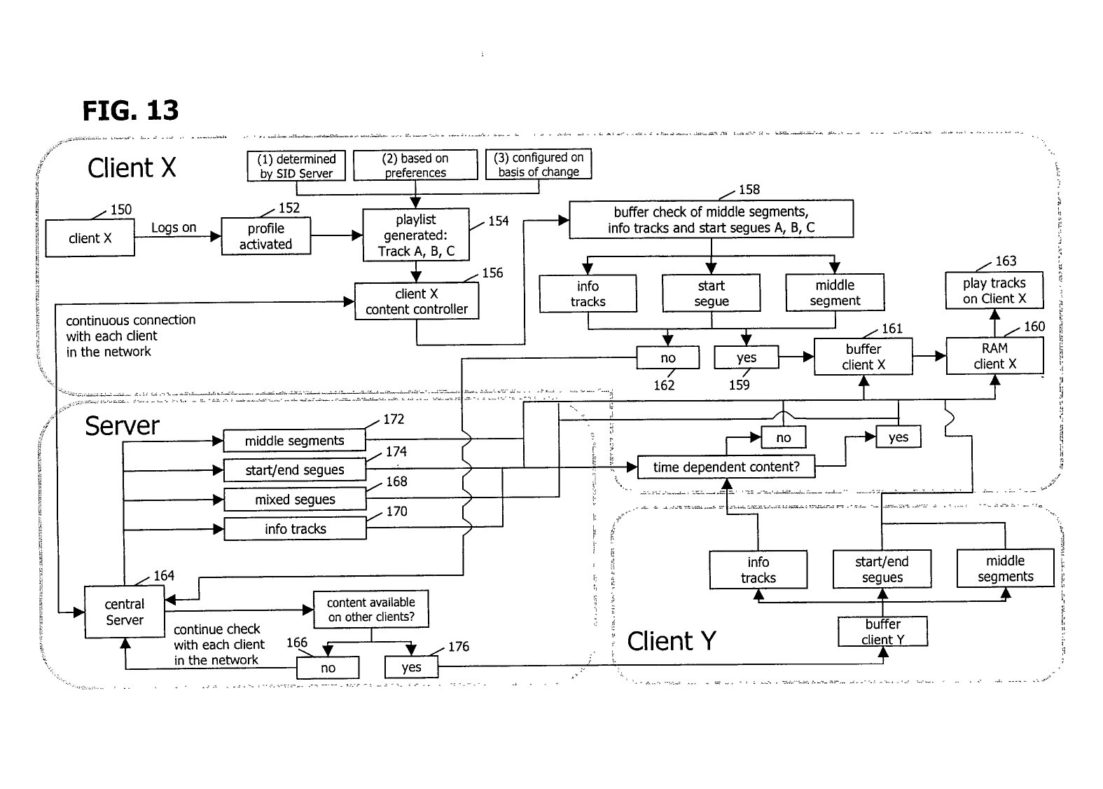

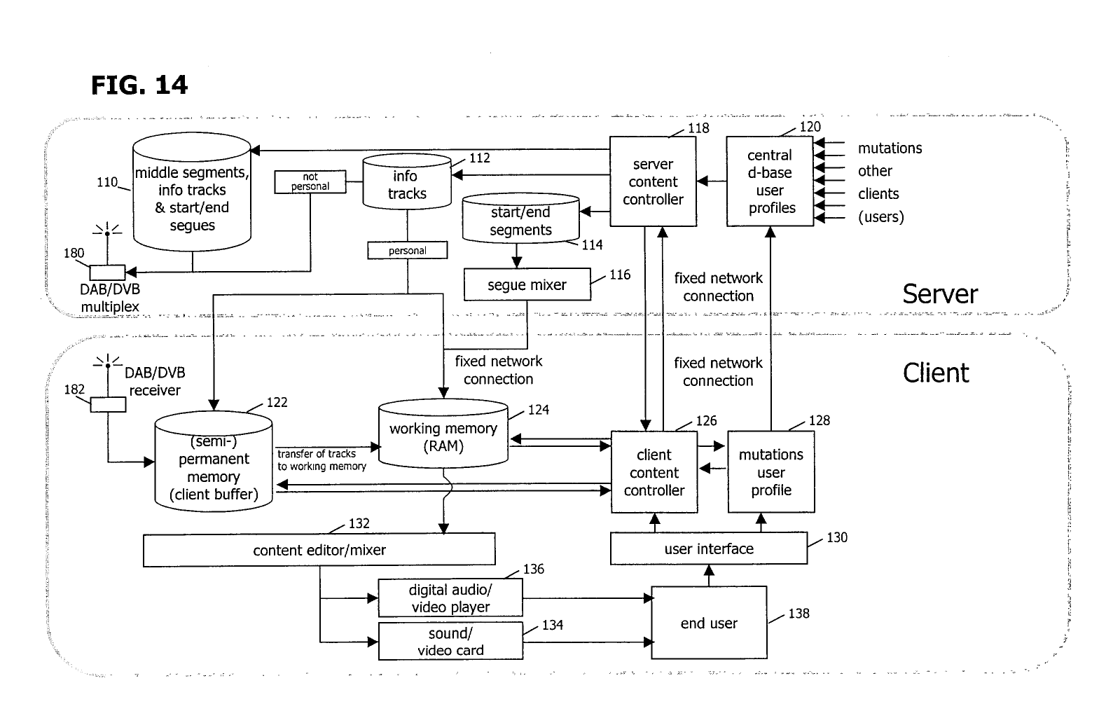

Breaking up of two original files in separate cut-off tracks and mixing into new composed tracks also offers a possibility to distribute start segues and middle segments via digital broadcast networks (DAB/DVB), storing them at the side of the individual client, so that they can be played back independently from the factor time. In that case, mixed segues are created at the request of the client and sent via interactive networks such as the Internet or mobile networks (see also FIGS. 13 and 14);

Combining of broadcast networks with interactive networks for sending cut-off files increases the efficiency of use of interactive networks, since sending individual streams of audio and/or video is no longer required. Distribution through (more expensive) interactive networks can suffice with a minimum of data, such as the missing segues and possible personal information for a user.

In principle, cutting files takes place at the server side. However, in another embodiment it is also possible for a client to receive a continuous (broadcast) stream of data, in which specific SID® codes are included which indicate at which points a separation between segments may take place. One can think of an application in which programs are transmitted sequentially (real-time), e.g. via DAB or DVB networks, while these programs can also be recorded by the client to be consumed later afterwards. Missing parts, such as the start and end segues and mixed segues, then arrive at the client via another network (internet or mobile), by which new combinations become possible (see also in the paragraph “COMBINATION BETWEEN BROADCAST AND INTERACTIVE NETWORKS”).

Combinations With Non-mixed Files (Info Tracks)

As FIG. 2 illustrates, not all tracks require a mix or perfect edit. The SID® technology is exceptionally suited for copyrighted works, for which substantial risk exists that they are copied onwards illegally. For certain tracks this is not applicable. One could think of tracks which are time specific (such as news announcements) and/or which are not at risk for being copied onwards (such as commercials). By using a combination (mix) of an end segment of a track with a jingle an “end segue” is created. Directly after this end segue non-mixed tracks may be played, possibly separated by distinguishing jingles. After these “info tracks” have been played, the program with tracks based on SID® technology can start again. FIG. 2 illustrates this with the creation in the server and playback in chronological order of mixed segue BC 30, middle segment C 32, end segue C 24, info track D 34, jingle 36, info track E 38, followed by start segue F 40 and middle segment F 42.

Creation of SID® Files with SID® Coding

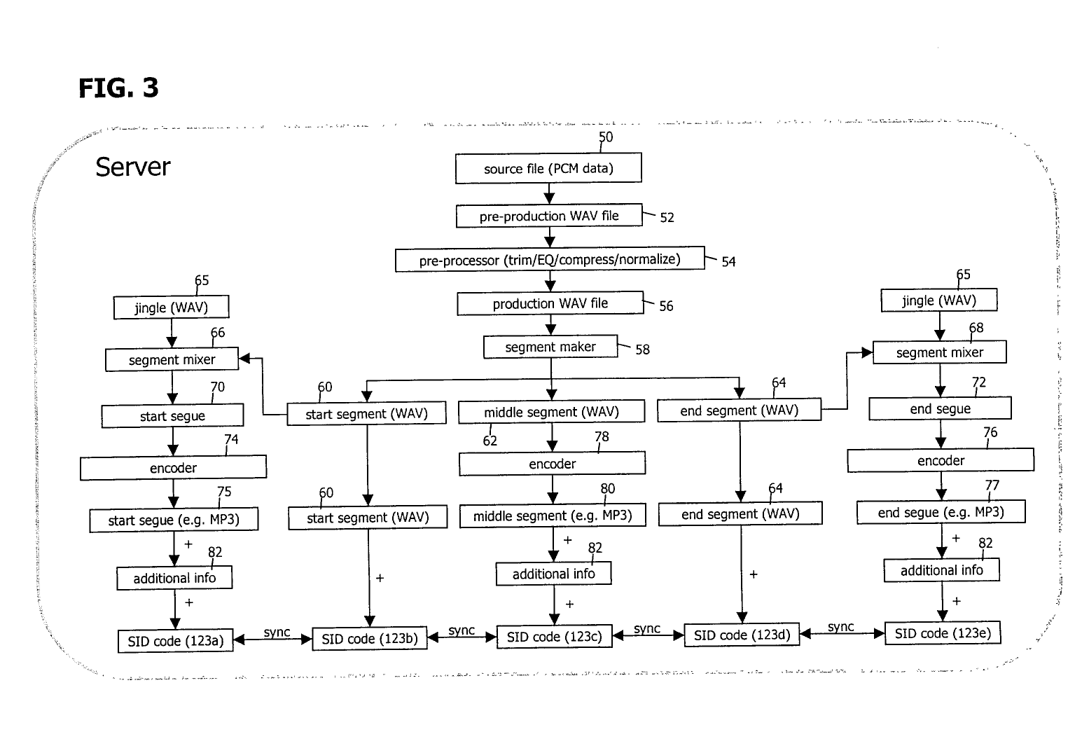

FIG. 3 shows the creation process of separate SID® files from one source file in further detail. Source files 50, mostly available in PCM data, go through a pre-production phase (illustrated in steps 52, 54 and 56), where several variables play a role. Silent parts at the start and finish of tracks are cut-off (“trim”), colouring of sound is adjusted by means of an equalizer, dynamics are taken from the original sound wave (“limiting & compression”) and equalization of sound levels is performed (“normalisation”). Use of these technologies are dependent from the needs of the user of SID® technology, but also from the specific qualities of the codec used to compress files after they have been created.

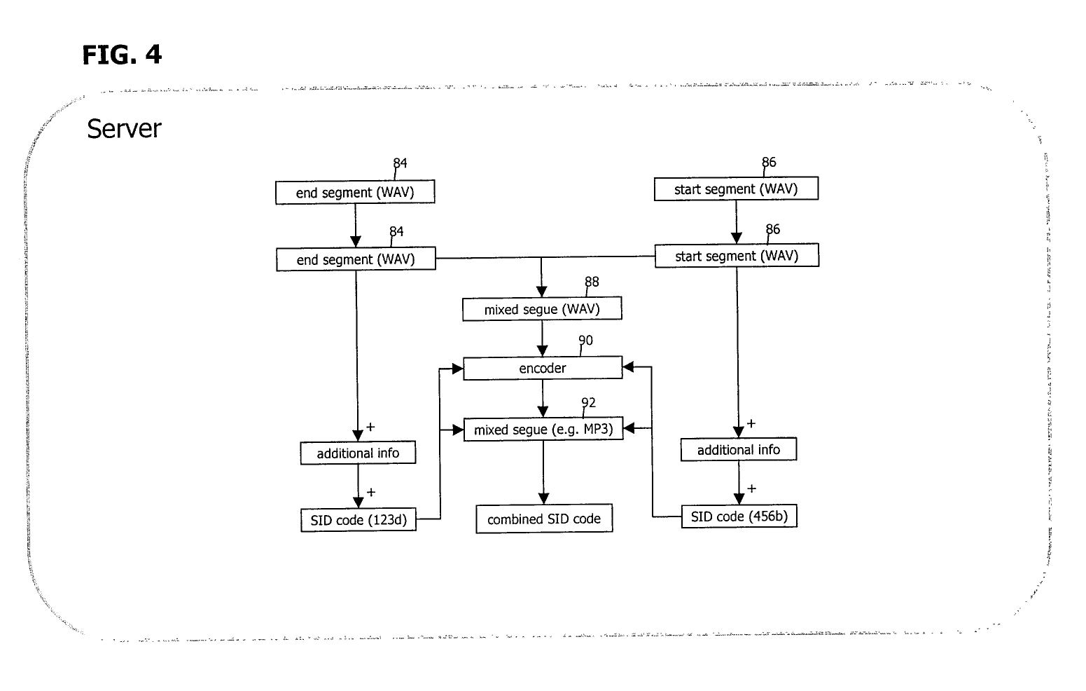

The result of this process is a production file 56, which is cut up by a segment maker 58 into three separate segments, being a start segment 60, a middle segment 62 and an end segment 64. Next, start the segment 60 and end segment 64 are copied, which are mixed with a jingle 65 or another sound file in a segment mixer 66, 68, respectively. The newly created start segue and end segue files 70 and 72, respectively, are sent through an encoder 74, 76, respectively, for the creation of compressed files 75 and 77, respectively. The middle segment 62 is also directly encoded with encoder 78 to a compressed file 80 (e.g. MP3). The original start and end segments 60 and 64, respectively, remain stored in the memory of the server in their original form, a unique SID® coding being assigned. The start and end segments are mixed together in a server-side determined order, as shown in FIG. 4. Additional information 82 may be added to the encoded files, again along with a unique SID® code, for example in a header of the file. The difference in coding between FIG. 3 and FIG. 4 is that the codes in FIG. 3 are largely similar, while the codes in FIG. 4 are a composite of two tracks combined by the server. FIG. 3 illustrates this with the use of codes 123a (start segue), 123b (start segment), 123c (middle segment), 123d (end segment) en 123e (end segue). The word “sync” between the different codes refers to a synchronisation process. Because the tracks belong together, they are all coded with “123”. In FIG. 4, the server creates a combination of end segment 84 of a file with SID® code 123d and a start segment 86 of a different file with SID® code 456b (where ‘b’ for example signifies to the server that it concerns a start segment). Mixed segue 88 is encoded by an encoder 90 to a compressed file 92, to which a combined SID® code is added, according to a predetermined process.

SID® codes can be added to the ID3v2 tag, which is the new informal standard (that is, not ratified by an official institution) within MP3 files. Such header-based techniques exist for video as well. Another possibility is to hide segue identification codes within the audio and/or video file as a watermark. Watermarking technologies offered by third parties can be used for this purpose. Another option is to create a separate file which provides information (meta-data) on the audio and/or video file.

Such ID3v2 tags, watermarks or separately created files provide crucial information to the server, which has to determine which files belong together and how the mix is to be made between music and/or motion picture files, jingles and commercials. Not all music and/or motion picture files are created in the same way, and a skilled person knows exactly how and when to create the best mix. Since with SID® the mix is not determined by a skilled person, but a computer server, this computer needs to be instructed on how to deal with the different styles of music and segues (e.g. “a capella” versus “fade out”). By categorising the audio and/or video on the basis of different variables, determining the start and end times and adding other information, make server created mixes possible. Apart from a coding 123b, other variables may be added which provide information about the track. Think of information such as the title of the track, a performing artist, a composer, a style of music and images of the artist or an album.

Adaptation of the Codec (Encoder/Decoder)

The invention aims to make use of compressed audio and/or video. Compression of audio and/or video is achieved by leaving out inaudible audio or encoding only the changes of the pictures (the delta). Together these compression techniques are referred to as “perceptual coding techiques”, because they only represent what is perceived by the end users. The best known technique was developed by the MPEG consortium, which is acronym for Moving Pictures Experts Group. MPEG was originally founded to achieve video compression, which essentially is a combination of audio and video. The MPEG-1 audio standard consists of three sub-standards, being layer I, II and III. Layer I in particular is suitable for high end professional use, while layer II and III have been developed for use in consumer products. Layer III is better known by the abbreviation MP3.

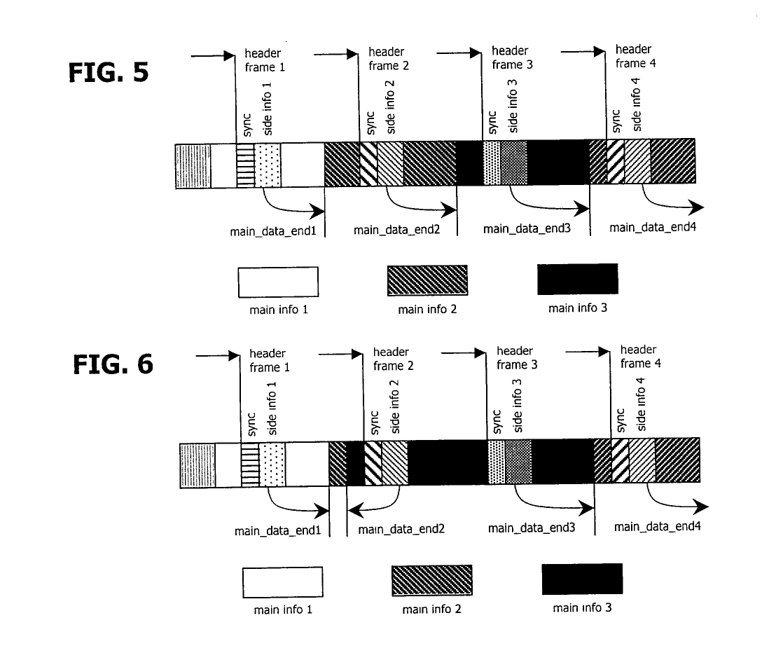

Data is transferred in frames, which can be individually decoded. The similarity between layer II and III is that both use an equal frame length, which consists of 1152 samples. The difference is in the level of compression. Samples in layer II files correspond to the frames they belong to. This makes it possible to edit, or cut and paste, layer II encoded files excellently. Because of this possibility of editing files, layer II was chosen in the Eureka 147 standard for DAB/DVB applications. Because not every frame requires 1152 samples to represent the audio, layer II realises less compression than layer III. In layer II there are non-used bits not representing audio, but counting in the file size. In contrast to layer II, layer III uses bit reservoirs. That is, non-used bits in a frame are added to a bit reservoir which can be used to represent audio which needs more than the available 1152 samples. In layer III the bits are organised differently: frames which belong to the bit reservoir, are placed before the real frame. This is illustrated in the figures from the ISO11172-3 standard, which are taken up here as FIG. 5 (the bitstream organisation according to MPEG-1 layer III, FIG. 3-A.7.1) and FIG. 6 (the bitstream organisation according to MPEG-1 layer III, FIG. 3-A.7.2, with an audio peak demand at “main info 3” and minimal demand for data space for “main info 2”). This is required because the audio has to be read before it can be played back. It is no use to use a bit reservoir which is for example 30 seconds later in the file, because it would not be included in the playback.

In other words, a layer III file contains little to no useless bits: the ‘air’ is taken out, as it were, which enables better compression than layer II. Because samples can be spread out over several frames, the consequence is that a layer III file cannot be edited discretely. To enable editing, the layer III file needs to be decoded to for example PCM data. In practice, when a user encodes a live CD (which consists of continuous tracks which are separated by codes on the CD) to MP3 format, a small tick (short silence) can be heard between tracks. This is a result of the decoder, which treats the files as discrete, which may result in addition of a new bit reservoir (in the form of zero or more frames) prior to the first frame. Depending on the peak level, several frames will be added. Any unused bits in these frames of a track can be perceived as silence. Normally spoken this does not matter, but with a required sharp edit in SID® files, this is quite a nuisance and undesirable.

The consequence of this would be that layer III (MP3), or codecs that use comparable coding techniques, in principle would be unsuitable for an application of the SID® technology, where precise cutting and subsequent pasting of files is essential. From the prerequisitive to be able to edit in DAB/DVB after encoding, one can understand why a qualitatively lesser compression format (layer II rather than layer III) was chosen. However, since the server in SID® technology determines the exact edit positions, the codec needs to be adapted in such a way that the decoder is capable of pasting together files at these crucial points, in order to avoid undesirable and audible segues. Adaptation of the codec at source code level is required, however. Although in the next paragraph two solutions are discussed for audio, these may be applicable mutatis mutandis to video as well.

There are two ways to solve the described problem. Essential to both solutions is that in the original track (commonly available as PCM data), the audio (and/or video) needs to be represented as a multiple of frames of equal length as the target format (MP3), being 1152 samples. This is required to make sure that the last frame in the encoded MP3 file is fully filled with bits (i.e. no non-used bits). This prevents the problem from occuring at the end of a file, and only at the beginning of the next file.

The first method is to instruct the codec such that bit reservoirs cannot be used around cutting points (for example between a start segment and a middle segment). In other words, the encoder cannot add additional frames to represent samples which do not fit within the standard 1152 sample frame length. The consequence is that the sound quality is at risk (since there is no space to represent all samples). In practice this solution results in a fluent transition of sound, but the audio quality can be sub-optimal.

A different method is to avoid possible additional frames for a bit reservoir from being counted in the time coding of the file. This can be achieved by setting a specific ‘private bit’ of these extra frames with a value ‘1’. Since normal frames have a private bit with a value ‘0’, the decoder can recognize the encoded frame(s) with value ‘1’ as frame(s) which are not to be included in the time coding of the file (but have to be read into memory), which would lead to a silence (‘tick’) between two discrete segments. The available empty frame(s) is or are available because the first next normal frame may need the space in the empty frame(s) to store data (bit reservoir). Thus, frames with a private bit ‘1’ are not included in the time coding, but serve to enable a fluent transition of discrete tracks. FIG. 7 illustrates the described process graphically, analogue to the description of the original ISO11172-3 standard. Apart from adjusting the private bits, adding a specific code in other places in the header of the encoded file is also a possibility.

Use of Memory

The basic implementation of SID® can be used in a form in which the tracks enter streamingly. However, the Internet was not created for streaming audio and/or video, because data are transported in small packets. Since these packets do not necessarily have to travel via the same route to the user, the stream may be interrupted. The Internet originally was a military application, where it did not matter along which path the packets were sent, as long as they would reach their destination. Continuity never was the discriminating factor. Applications for streaming audio and/or video generally use a temporary buffer—a small memory that records data in order to avoid interruptions in continuity of receipt of packets. To completely overcome this problem, more permanent memory may also be used which records data not temporarily as a part of a stream, but as discrete files. Audio and/or video which is played back frequently, only needs to be sent once, which enables substantial savings in traffic (and hence costs). In order to guarantee continuity, it is essential that sufficient data are present in the memory.

As FIG. 1 and 2 also illustrate, this preferred embodiment of SID® technology uses a memory in the client, which is referred to as a client buffer. Computers know two kinds of memory—permanent or Read Only Memory (ROM) and rewritable or Random Access Memory (RAM). A characteristic of the latter kind of (computer) memory is that it does not have to be of permanent nature. We know RAM best as the working or active memory which is cleared as soon as the computer is turned off. This active memory contains the tracks scheduled in the playing sequence. The client buffer, on the contrary, relates to a more permanently reserved piece of memory. This may be a section on the hard disc of the client, which may be fixed or flexible in size. A fixed size has a maximum to the available space for storage of files (e.g. 1 gigabyte). A flexible storage method has no limits to the capacity (apart from the physical limits of total available memory). SID® technology may use both kinds of memory to store files temporarily or permanently. Start segues, middle segments and end segues of audio, video and/or info tracks will be stored in the client buffer, while mixed segues and info tracks with a time constraint (e.g. news) or with a personal character (a spoken message) will generally be stored in RAM memory, or temporarily in the client buffer. After playback of a track in a predetermined order, the chance that such an order will reoccur in future playback is statistically small. This does not hold true for off-line storage, as discussed later in this document. If each mixed segue file would be stored on the client-side, the reserved or available memory would fill up instantly. Many combinations between files are possible, after all.

Use of Skip Functions

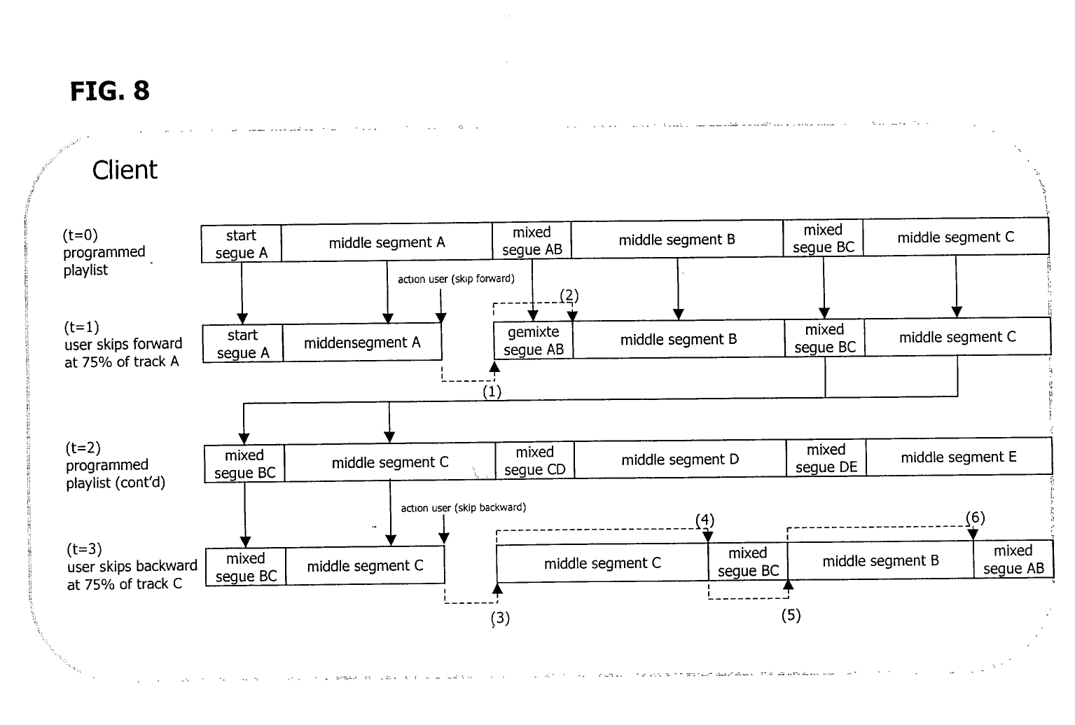

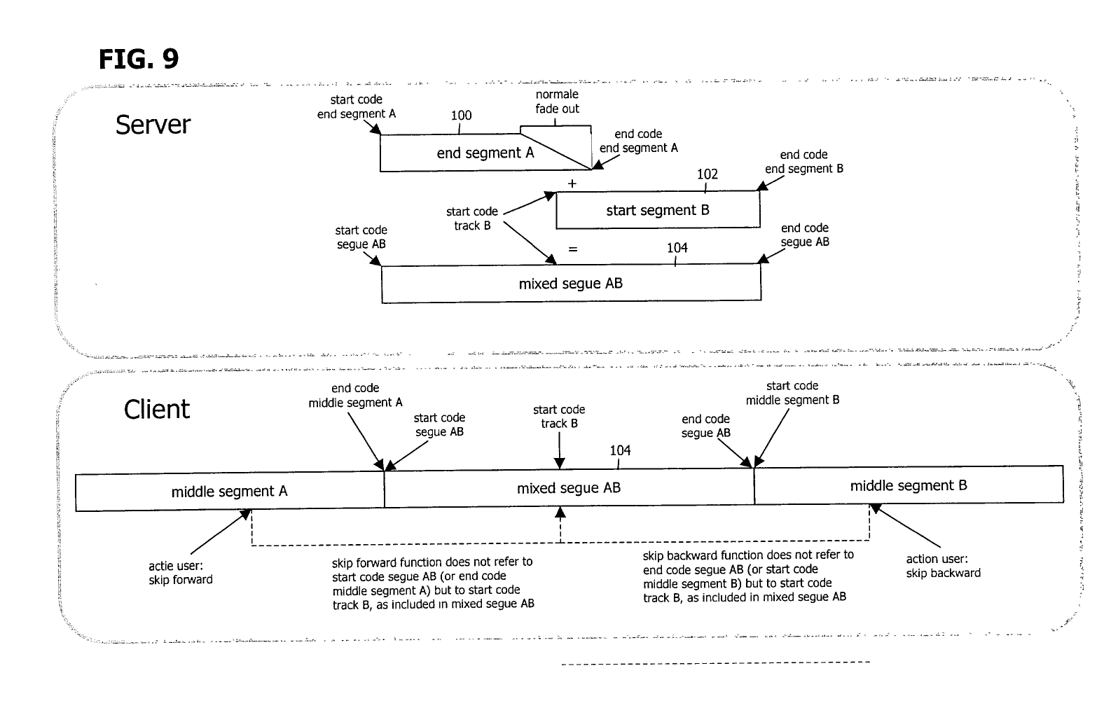

The availability of cut-off tracks on the side of the client would result in abnormal functioning of forward or backward skip buttons of a player (as featured on a CD-player). As illustrated in FIG. 8, a user induced action of the forward skip function from track A to track B, would result in the playback of the start of mixed segue AB (arrow (1) in FIG. 8). The user would therefore hear the last tones of track A and subsequently a mix with track B. Pressing the forward button again results in playback of the middle segment of track B (arrow (2) in FIG. 8). In this case the user misses the initial tones of track B. When a user decides to skip backward to a previous track, a comparable effect occurs, although several skips are required. In FIG. 8, in order to skip back during track C back to mixed segue AB (which features the first tones of track B), it is necessary to push the backward button four times. FIG. 8 illustrates this with arrows (3) to (6).

There are other means to enable a skip function. First, it is possible to include an identification code to the mixed segue AB to the point where track B begins. This is illustrated in FIG. 9. The process of creation of a mixed segue AB out of the combination of end segment A 100 and start segment B 102 is shown. Each original segment has a start and end code. However, during the creation of mixed segue AB 104 the start code of track B is included in the header as the point to which the forward or backward skip function points in the client. As featured in the lower client part of FIG. 9, the end code of middle segment A is synchronised with the start code of mixed segue AB, and the end code of mixed segue AB with the start code of middle segment B. When either the forward or backward skip function is used, the client refers to the position in mixed segue which includes start code B.

One aspect to this first method is that users will always hear the first sound and/or see the first images of a new track mixed with the last sound and/or the last images of the track with which it is mixed in the segue. Although possibly annoying to the listener/viewer, discouragement of copying is a primary aspect of SID®. Skipping between tracks prior art mixed CDs results in a similar effect. In this case tracks are separated discretely by means of PQ codes. The codec needs to be instructed in such a way that the use of skip functions refers to these specific identification codes within the mixed segues.

A second, more elaborate solution may initially be implemented especially in devices which know little or no pre-buffering, because the audio and/or video does not need to stream from server to client, but is already downloaded in a memory. To enable skip functions without hearing/seeing the first sound/images of a new track mixed with the last sound/images of a track with which it is mixed in the transition, such devices need to be adapted to support the following process.

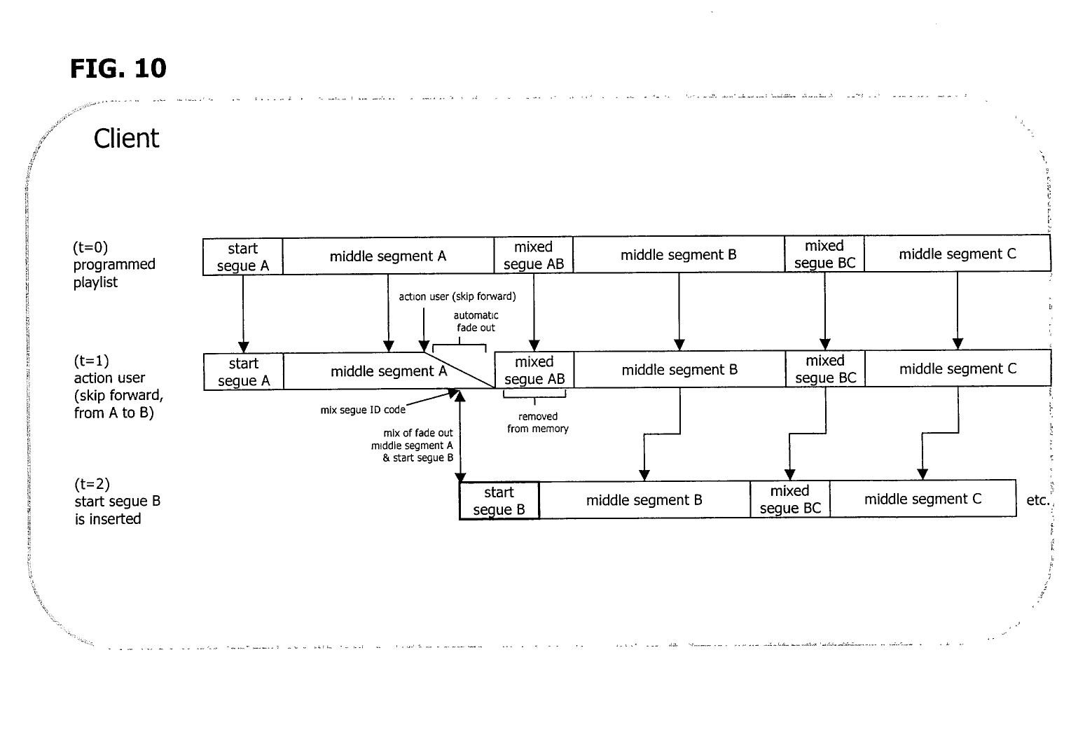

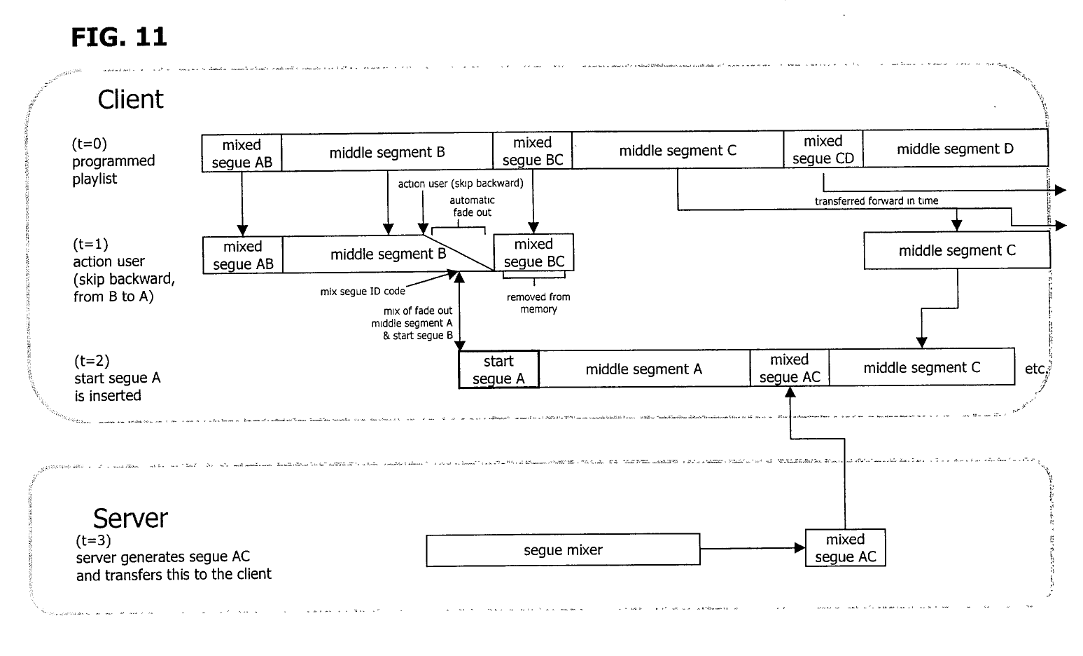

As illustrated in FIG. 10, when a user presses the forward skip function (in this case from track A to track B), the client application would start an automatic fade out and/or dissolve (as opposed to a normal fade out at the end of a track), which brings back the audio or video level from 100% to 0% in a predetermined time period, such as three to five seconds after the skip function has been pressed. When the fade out and/or a dissolve has reached a predetermined level, for example 70% or 60% (or a certain dB level), an application program will generate a “mix segue identification (ID) code” (see FIG. 10 and FIG. 11), which triggers the mix with the start segue of the track to which the user skips (track B in FIG. 10; track A in FIG. 11). In an application for video the transition may use a combination of fade out of the sound and a dissolve of the image. Principally this method of skipping can be used in each of the files. The use of the skip function within segues, however, may result in a mix of many different sounds and/or images. When a user skips midway during a mixed segue to a next track, a new mix will be created out of this mixed segue and a start segue, which already is a mix of a start segment and a jingle. In a different embodiment a choice can be made not to create a mix of two segues, but to play these files sequentially. The previously mentioned mix segue identification code then becomes the point where the sound is cut off abruptly and the start segue of the next or previous track is started.

FIGS. 10 and 11 also illustrate the consequences of the use of skip functions when the server, not the client, determines the playlist order. In FIG. 10, the mixed segue AB which was scheduled without the use of the skip function in the playlist, loses its function. This file is only required in case the user again decides to skip backward to track A anywhere in track B. However, as long as track A is not featured in chronological order, it will be deleted from the active (RAM) memory. Other files scheduled in the playlist appear to be shifted forward in time. The use of the backward skip function in FIG. 11 has as consequence that the mixed segue BC is deleted from memory, or, in case the playlist is fixed, is shifted backward in time. However, in case the server determines the order of the playlist and hence a track C is featured after track A, a new mixed segue AC will be created by the server and transferred to the client. The files which were scheduled in the original playing order (such as middle segment C in FIG. 11) are thus shifted forward in time.

Communication Process Between Client and Server

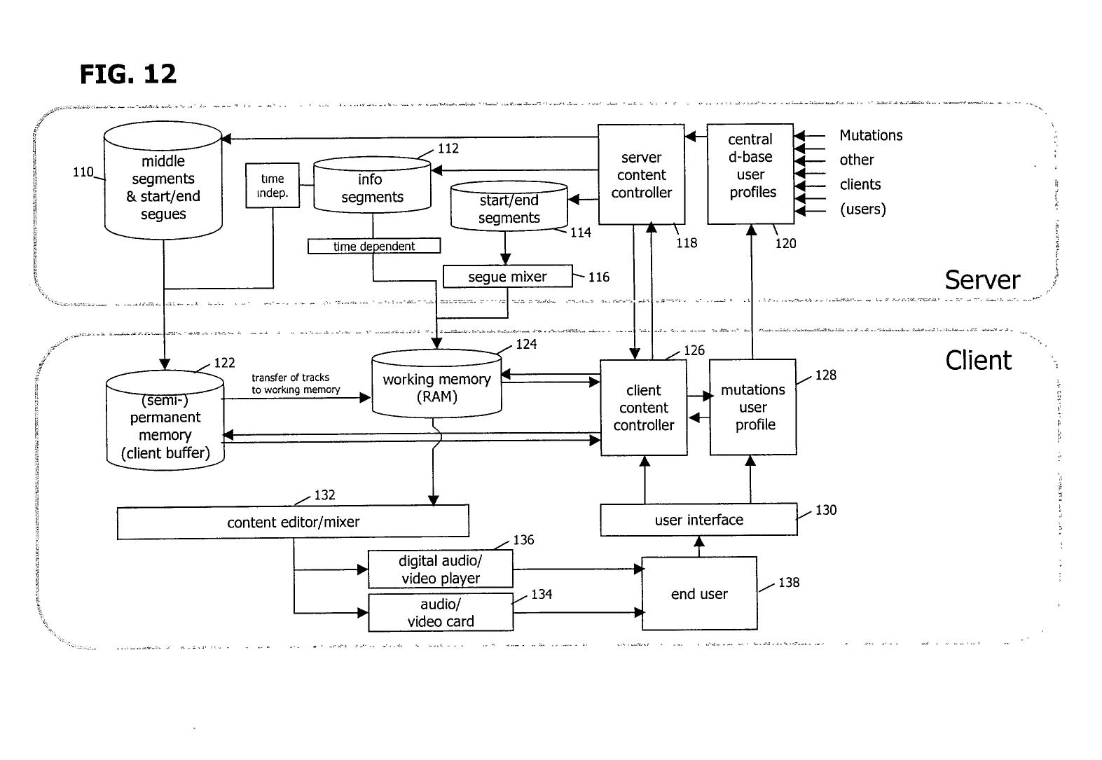

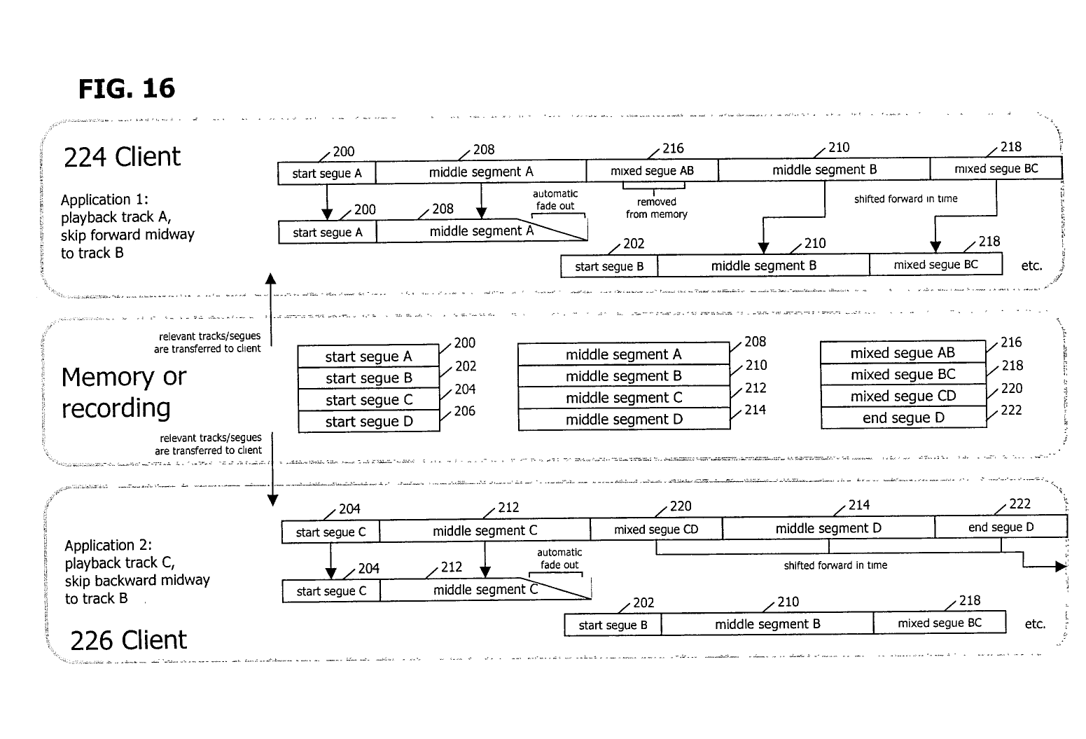

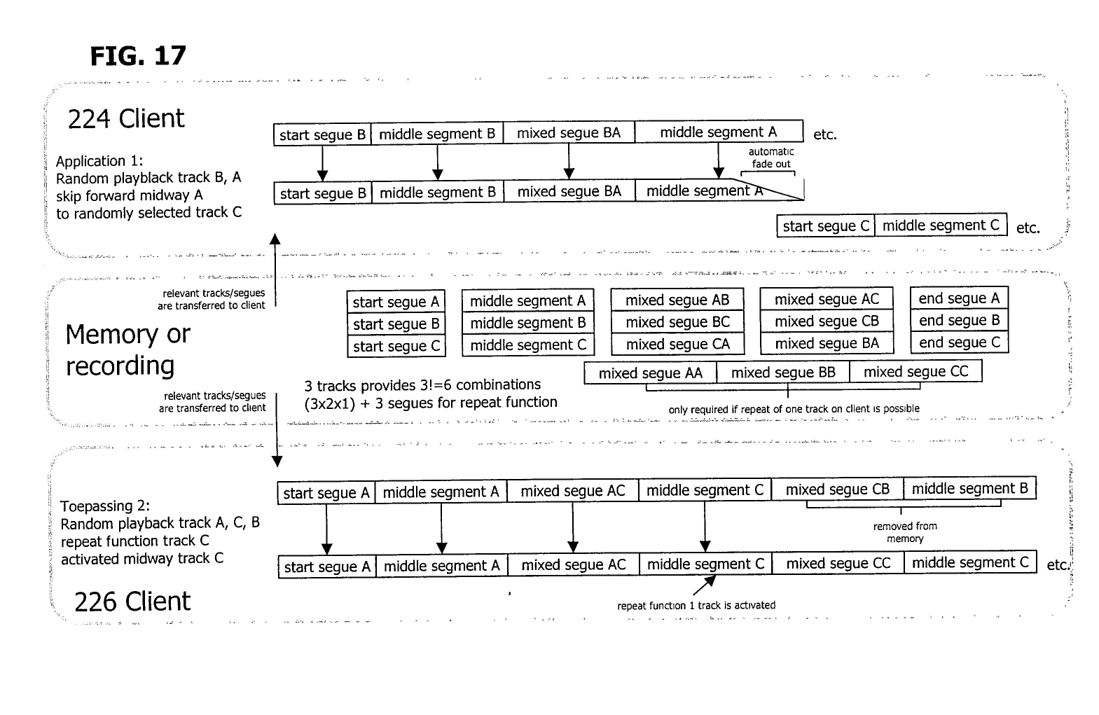

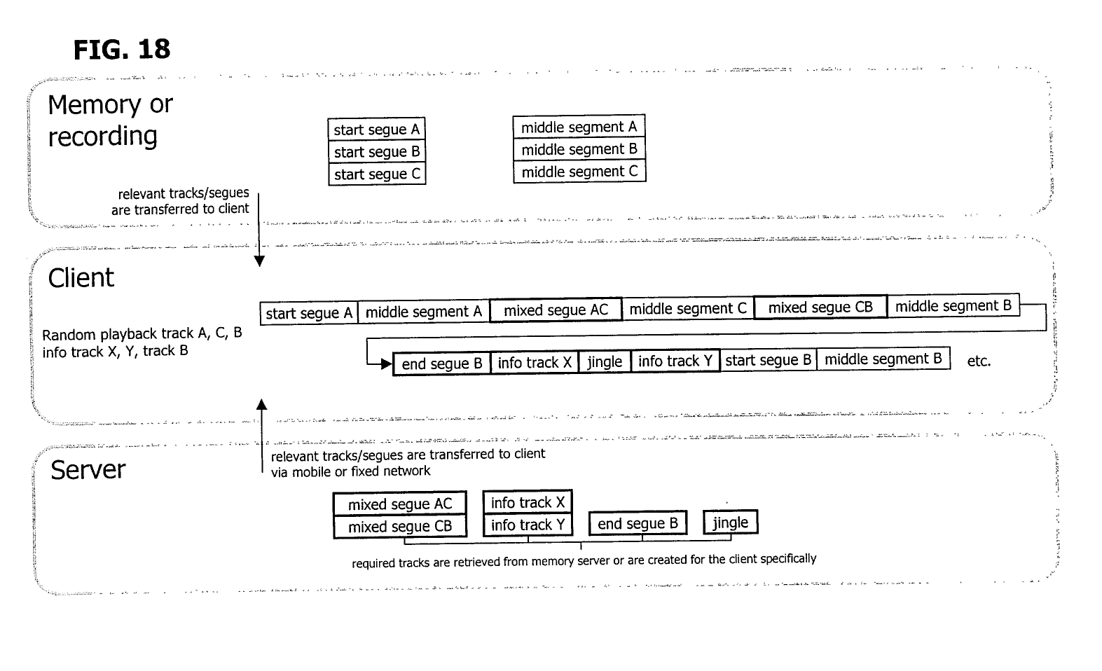

SID® technology has applications in both online and off-line versions. The difference is whether or not there is a connection with a network. With online use of the SID® technology, the available files are dynamic rather than static. That is, new files can be added in the playlist order. One can think of new tracks or news items. In an off-line version there is no regular or continuous network connection, which makes it impossible to add such tracks. FIGS. 12, 14, and 15 describe the communication process between a client and a server, while FIG. 13 describes the communication process between a server and one or more clients. FIGS. 16 and 17 and the paragraph “OFF-LINE USE” describe the process of off-line usage. FIG. 18 describes the use of a combination between dynamic and static media.

As FIG. 12 shows, the server holds three kinds of memory (databases). Memory 110 contains the middle segments, start and end segues which have between created once from the original tracks (FIG. 3) and then are recorded. Memory 112 contains unmixed info segments (announcements, news, commercials etc.) which may have both a time-dependent (news) and time-independent (commercials) character. In an online version also other info tracks can be added to this memory, which have, for example, a personal character. Think of news that is targeted to a select group of users or messages intended for individuals. The application of “Music Mail” which will be described later is an example. Memory 114 contains the start and end segments, which are mixed to segues in the segue mixer 116. The three kinds of memory 110, 112 and 114 are controlled by a “server content controller” 118 which regulates traffic between the server and the client, and determines which server memory transfers files to separate clients. The server segment controller 118 depends on information from a central database 120 which includes profiles of individual users. Profiles are stored in this database and matched with each other. Possible reporting from the system is created from this memory.

The client features two kinds of memory: a (semi-)permanent reserved piece of memory 122 and a short memory 124. A client content controller 126 regulates traffic between memory 122 and 124 and is connected in an online version permanently (or very regularly) with the server content controller 118. Mutations in the user profile 128, which are received from user interface 130, influence the client content controller 126 and are recorded in the central profile database of the server 120. Tracks scheduled in the playlist (as determined by client content controller 126) are transferred from the (semi-)permanent memory 122 to the short memory 124. The working memory 124 is connected with a content editor/mixer 132 which mixes and/or pastes together and sends tracks to an audio and/or video card 134 or a digital player 136. An end user 138 finally hears and/or sees the tracks and may influence these by means of the user interface 130. The user interface 130 features functions such as skip forward and/or backward and functions for determining preferences (e.g. through a thumbs up, thumbs down principle). In principle, time dependent tracks are transferred to the working memory 124 directly. Time independent tracks are transferred to the (semi-)permanent memory 122.

Communication Process Between Several Clients and a Server

As illustrated in FIG. 13, the playlist may be determined by the server, based on previously registered preferences from (individual) users, or configured on the basis of change. Responsiveness between client(s) and server is the discriminating factor here. Because the SID® technology creates and distributes discrete files in a network, not all traffic has to come from a central server. In an embodiment of SID®, the server may suffice with co-ordination of data traffic between clients in the network. SID® technology is therefore perfectly suited for so-called peer-to-peer applications, where traffic can also be exchanged between clients directly.

The advantages of such an application include:

More efficient use of the capacity within the network. Direct relationships reduce the necessity of directing all traffic via the central server.

This enables more individual streams with equal bandwidth.

Possibility for the server (=interactive radio and/or TV station) to generate segues with commercials, which enables a comparable business model as used on traditional radio and/or TV.

FIG. 13 is a schematic representation of the process of exchange of tracks between a client X, a server and a client Y. After client X 150 has logged on, the profile of the user is activated (as indicated with 152) and a playlist of tracks A, B, C is created (indicated with 154). A content controller 156 of client X checks whether the required middle segments, info tracks and start segues are available in a client buffer X (as indicated with 158). If this is the case (indicated with “yes” 159) the tracks are transferred via a buffer 161 to the working memory 160, to be scheduled for play (as indicated with 163). Should any of these tracks not be present (indication “no” 162), contact is made with the central server 164, which checks for availability of tracks (content) on other clients which may transfer them faster (hence cheaper). When this is not the case (as indicated with 166), the server 164 retrieves the desired tracks from the databases, and/or the server 164 generates mixed segues from start and end segments. In principle, mixed segues 168 and info tracks 170 with a time-dependent character are transferred directly to the working memory 160. Middle segments 172, start and end segues 174 and info tracks 170 with a time independent character are transferred to client buffer 161. In case the required tracks are also available from other clients in the network (as indicated with 176), the server 164 chooses the client capable of delivering these tracks via the shortest and/or most reliable route. FIG. 13 illustrates this with traffic between client Y and X.

Combination Between Broadcast and Interactive Networks

Due to the segmentation into discrete files, the SID® technology is very well suitable for applications with combinations between broadcast and interactive networks. Digital broadcast systems include Digital Audio Broadcasting (DAB) and Digital Video Broadcasting (DVB). Essentially, these are digital variants of analogue systems (AM/FM/VHF). Although these digital variants feature a one-way communication direction, they are much more efficient than their analogue predecessors. While analogue frequencies can only carry one signal, for example the Eureka 147 standard of DAB/DVB features the use of a so-called multiplex, which is a composite of several layers of audio and/or video. A DAB multiplex may carry 7 layers of audio, each of which are encoded at 192 kbps. This sound quality is almost equal to CD-quality, which is used as the most important argument for end users to convince them to make the transition from analogue to digital. DAB is already operational for several years, but end users up to now have not recognised the usefulness and necessity of this digital variant. Broadcasters, in turn, are not eager to invest in DAB, since there are nearly no end users with digital receiving equipment. Possibly, quality may not be a differentiating factor, but interactivity. A choice which then can be made is to deliver more signals at lower quality levels via the multiplex. For each 192 kbps signal, three signals of 64 kbps can be transmitted, which allows for 21 rather than 7 concurrent signals. However, in order to enable interactivity between a client and a server, a return path needs to be available on the receiver. This can be both via fixed networks (telephone, cable, electricity) as mobile networks (e.g. GPRS/UMTS/Bluetooth).

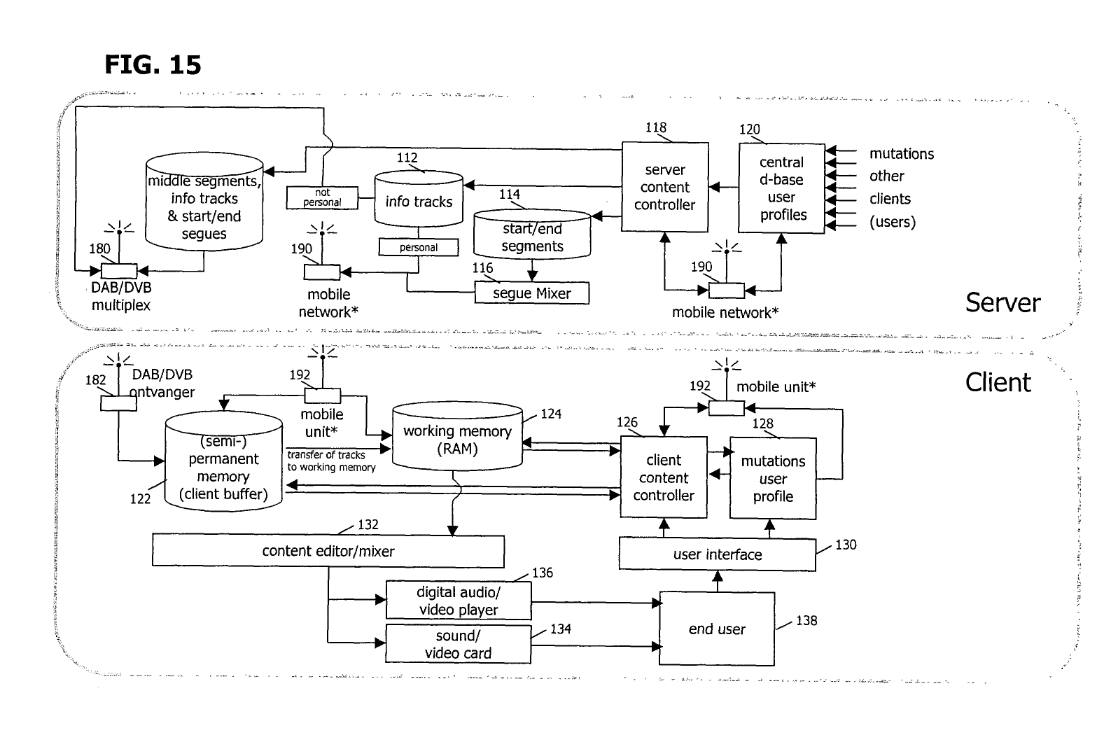

FIG. 14 is a schematic representation of the combination between a digital broadcast system and a fixed network. FIG. 15 features a schematic representation of a combination between a digital broadcast system and a mobile network. The communication process between client and server in FIGS. 14 and 15 is different from the process described in FIG. 12 in certain aspects. Since a broadcast network transfers information suitable for large groups of users, personal info tracks will not be transmitted via a DAB/DVB multiplex, but via an individual connection over a fixed network. The DAB/DVB multiplex 180 is very well suited for transfer of middle segments, segues and info tracks which may be recorded by a large group of users via a DAB/DVB receiver 182 in the client buffer 122. In this process, not every user will record the same, as this depends on the individual profile. On the basis of this profile and the SID® codes in the files, the client content controller 126 recognises the tracks which suit end user 138 best. Other tracks are not stored. Missing elements and info tracks with a personal character are obtained through a fixed network connection. The other communication between client and server also takes place over this network. FIG. 15 shows a nearly identical process as FIG. 14, with the exception that in the former figure the interactive communication is not transferred over a fixed but over a mobile network connection 190, 192.

Off-line Use

Previous paragraphs have discussed an application of the SID® technology in interactive networks. SID®, however, can also be used in static media, such as a CD, DVD or SACD or a fixed hard disc or so-called flash memory, as available in a computer or mobile devices such as a Personal Digital Assistant (PDA) or digital audio player (e.g. MP3). Physical carriers (CD, DVD or SACD) with SID® content can be made available via traditional channels, while a fixed hard disc or flash memory may be updated via an interactive network connection.

Since SID® does not make tracks available in full to the end user (=discouragement of copying), this results in limitations to the end user. FIG. 16 shows the exchange process between the client application and a static medium. Here, the static medium is referred to as “memory or recording” and contains start segues 200, 202, 204, 206 and middle segments 208, 210, 212, 124 of tracks A, B, C and D and the mixed segues AB, BC, CD and end segue D 216, 218, 220 and 222, respectively. These separate tracks only enable one chronological playlist. However, because start segues 200, 202, 204 and 206 are included as separate files, the user may use the skip functions. Analogous to FIGS. 10 and 11, the use of the forward skip function is shown in application 1 in client 224 and the use of the backward skip function in application 2 in client 226.

It is also possible to provide the end user with the possibility to playback the tracks in any order, in case all possible combinations are stored in the memory or on the recording. The faculty of 3 tracks results in 3×2×1=6 possible combinations. 10 tracks, however, would result in 3.628.800 combinations. Current storage media are not capable of carrying such a large number of combinations, but this may change in the future. A middle ground may also be possible. One can imagine a number of pre-determined combinations by experts (DJ's), which is equivalent to a set of playlists. The difference between FIGS. 16 and 17 is the number of files recorded. One of the functionalities may include the repeat function, which is e.g. known from a CD-player. As FIG. 17 shows for client 226, instead of playing a complete track C continuously and discretely, the client application plays the tracks as follows: start segue C, middle segment C, followed by a repetition of mixed segue CC and middle segment C. When the repeat function is deactivated the application chooses either end segue C or another available mixed segue (such as CA and CB in FIG. 17).

Apart from possibilities to store or record tracks for off-line use, it is also possible to create a combination between online and off-line use. One can imagine the distribution of start segues and middle segments via a physical carrier, while missing segues and possible info tracks are transferred over a fixed, mobile or broadcast network. FIG. 18 is a graphical representation, where available elements are taken from the memory or recording, while missing elements (boldly outlined) are transferred from the server. When these are not played via streaming audio and/or video, they can be stored in the (semi-)permanent client memory, analogous to FIG. 12.

Music Mail

Another application of SID® is Music Mail. After a user has selected a song in a database file on a server, he/she is stimulated to dial a fixed telephone number to leave through the telephone a personal message for a beloved person. This friend will then receive, directly or indirectly via a hyperlink in an e-mail message, a Music Mail, which consists of a mix of the personal message, a jingle and an audio track, mixed according to SID® technology. This Music Mail will stream from the server to the client. Such messages may also be recorded as download in the digital audio devices or recorded on static media such as a compact disc or digital versatile disc (in case an application for video is developed).

What is claimed is

1. A method for making available from a first party to a second party a number of digital files being member of a group of digital files comprising audio files, video files, mixed audio and video files, and parts thereof, the group of digital files comprising at least a first file, a second file and an other file, the method comprising:
creating by the first party of an intermediate segue file with a mix of an end segment of the first file, and a start segment of the second file;
creating by the first party of a first shortened file with at least a middle segment of the first file, and without the end segment of the first file;
creating by the first party of a second shortened file with at least a middle segment of the second file, and without the start segment of the second file; and
transferring the first shortened file, the intermediate segue file, and the second shortened file to the second party.

2. The method according to claim 1, further comprising:
creating by the first party of a first start segue file with a mix of a start segment of the first file, and an other file;
creating by the first party of a third shortened file with at least a middle segment of the first file, and without the start segment of the first file; and
transferring the third shortened file, and the first start segue file to the second party.

3. The method according to claim 1, further comprising:
creating by the first party of a first end segue file with a mix of the end segment of the first file, and an other file; and
transferring the first shortened file, and the first end segue file to the second party.

4. The method according to claim 1, further comprising:
creating by the first party of a second start segue file with a mix of the start segment of the second file, and an other file; and
transferring the second start segue file and the second shortened file to the second party.

5. The method according to claim 1, further comprising:
creating by the first party of a second end segue file with a mix of an end segment of the second file, and an other file;
creating by the first party of a fourth shortened file with at least a middle segment of the second file, and without the end segment of the second file; and
transferring the fourth shortened file, and the second end segue file to the second party.

6. The method according to claim 1, further comprising:
creating by the first party of at least one of a first start segue file, a first end segue file, a second start segue file, and a second end segue file, respectively, with a mix of at least one of a start segment of the first file, the end segment of the first file, the start segment of the second file, and an end segment of the second file, respectively, and an other file; and
transferring at least one of the first start segue file, the first end segue file, the second start segue file, and the second end segue file, respectively, to the second party.

7. The method according to claim 1, further comprising:
creating by the first party of at least one of a first start segue file, a first end segue file, a second start segue file, and a second end segue file, respectively, by processing at least one of a start segment of the first file, an end segment of the first file, a start segment of the second file, and an end segment of the second file, respectively; and
transferring at least one of the first start segue file, the first end segue file, the second start segue file, and the second end segue file, respectively, to the second party.

8. The method of claim 7, wherein the processing comprises at least one of trimming, equalizing, limiting, compressing and normalizing.

9. The method according to claim 1, wherein one of the first shortened file, and the second shortened file, respectively, contains one of a middle segment of the first file, and the second file, respectively, without the start and end segments of one of the first file, and the second file, respectively.

10. The method according to claim 1, further comprising:
creating by the first party of at least one user profile linking a user to at least one type of digital files;
selecting shortened files and segues in accordance with the at least one user profile; and
transferring the shortened files and segues to the at least one user.

11. The method according to claim 1, wherein the transfer of at least one of the digital files is made via at least one of a fixed network connection, a mobile network connection, and a broadcast connection.

12. The method according to claim 11, wherein the transfer of at least the first shortened file and the second shortened file is made via a broadcast connection.

13. The method according to claim 11, wherein the transfer of at least one of the segue files is made via at least one of a fixed network connection and a mobile network connection.

14. The method according to claim 1, wherein said other file is a member of a group of other files comprising any audio data, audio data containing a person's voice, any video data, a jingle, a commercial and an identification of a provider.

15. The method according to claim 1, wherein at least two files of the group of digital files originate from different sources.

16. The method according to claim 15, wherein the sources are part of a group of sources comprising a memory of a server, a memory of a third party, and a data carrier.

17. The method according to claim 1, wherein the audio files are MP3 files.

18. The method according to claim 1, wherein the video files are MPEG files.

19. A method for making available from a first party to a second party a number of digital files being member of a group of digital files comprising audio files, video files, mixed audio and video files, and parts thereof, the group of digital files comprising at least a first file, the method comprising:
creating by the first party of a first end segue file with a mix of an end segment of the first file and an other file;
creating by the first party of a first shortened file with the first file without the end segment of the first file; and
transferring the first shortened file and the first end segue file to the second party.

20. A method for making available from a first party to a second party a number of digital files being member of a group of digital files comprising audio files, video files, mixed audio and video files, and parts thereof, the group of digital files comprising at least a first file, the method comprising:
creating by the first party of a first start segue file with a mix of a start segment of the first file and an other file;
creating by the first party of a first shortened file with the first file without the start segment of the first file; and transferring the first start segue file and the first shortened file to the second party.

21. A system for making available from a first party to a second party a number of digital files being member of a group of digital files comprising audio files, video files, mixed audio and video files, and parts thereof, the group of digital files comprising at least a first file and a second file, the system comprising:
means for storing by the first party of the first file and the second file;
means for creating and storing by the first party of an intermediate segue file with a mix of an end segment of the first file, and a start segment of the second file;
means for creating and storing by the first party of a first shortened file with at least a middle segment of the first file, and without the end segment of the first file;
means for creating and storing by the first party of a second shortened file with at least a middle segment of the second file, and without the start segment of the second file; and
means for transferring the first shortened file, the intermediate segue file, and the second shortened file to the second party.

22. A system for making available from a first party to a second party a number of digital files being member of a group of digital files comprising audio files, video files, mixed audio and video files, and parts thereof, the group of digital files comprising at least a first file, the system comprising:
means for storing by the first party of the first file;
means for creating and storing by the first party of a first end segue file with a mix of an end segment of the first file and an other file;
means for creating and storing by the first party of a first shortened file with the first file without the end segment of the first file; and
means for transferring the first shortened file and the first end segue file to the second party.

23. A system for making available from a first party to a second party a number of digital files being member of a group of digital files comprising audio files, video files, mixed audio and video files, and parts thereof, the group of digital files comprising at least a first file, the system comprising:
means for storing by the first party of the first file;
means for creating and storing by the first party of a first start segue file with a mix of a start segment of the first file and an other file;
means for creating and storing by the first party of a first shortened file with the first file without the start segment of the first file; and
means for transferring the first start segue file and the first shortened file to the second party.

24. The system according to claim 21, further comprising:
means for creating and storing by the first party of at least one user profile linking at least one second party to at least one type of digital files;
means for selecting by the first party shortened files and segues in accordance with the at least one user profile; and
means for transferring the shortened files and segues to the at least one second party.

25. The system according to claim 21, wherein the means for transferring comprise at least one of a fixed network connection, a mobile network connection, and a broadcast connection.

26. The system of claim 25, wherein the network connection comprises at least one of a cable connection, a satellite connection, a GPRS connection, a UMTS connection, a UWB connection, a wireless LAN connection, a Bluetooth connection, and an Internet connection.

27. The system of claim 25, wherein the broadcast connection comprises at least one of a DAB connection, and a DVB connection.

28. A player for use by a second party for playback of digital files being member of a group of digital files comprising audio files, video files, mixed audio and video files, and parts thereof, the digital files being created and transferred from a first party according to any of claims 1-12, the player comprising:
at least one memory for storing the digital files;
reproducing means for reproducing the digital files;
a content controller for controlling the reproduction order of the digital files.

29. The player according to claim 28, wherein the at least one memory stores at least a part of a first file contained in a first start segue file and a corresponding first middle segment file, and at least a part of a second file, the content controller being adapted for skipping backward from the second file to the first file by fading out the second file and skipping to the first start segue file.

30. The player according to claim 28, wherein the at least one memory stores at least a part of a first file, and at least a part of a second file contained in a second start segue file and a corresponding second middle segment file, the content controller being adapted for skipping forward from the first file to the second file by fading out the first file and skipping to the second start segue file.

31. The player according to claim 28, comprising at least one of a digital audio player, a digital video player, an MP3 player, an MPEG player, a mobile phone, a Personal Digital Assistant, an Internet set-top box for TV, and a supervideorecorder.

32. The player according to claim 28, wherein the memory comprises at least one of a recordable digital carrier, a rewritable digital carrier, a CD, a CD-R, a CD-RW, a DVD, a DVD-R, a DVD-RW, a SACD, an optical disk, a flash memory, and a RAM memory.

33. A computer program product containing program instructions stored on a storage medium, for performing a method of making available from a first party to a second party a number of digital files being member of a group of digital files comprising audio files, video files, mixed audio and video files, and parts thereof, the group of digital files comprising at least a first file, a second file and an other file, the method comprising:
creating by the first party of an intermediate segue file with a mix of an end segment of the first file, and a start segment of the second file; creating by the first party of a first shortened file with at least
a middle segment of the first file, and without the end segment of the first file;
creating by the first party of a second shortened file with at least a middle segment of the second file, and without the start segment of the second file; and
transferring the first shortened file, the intermediate segue file, and the second shortened file to the second party.
